(19) United States
(12) Patent Application Publication
(10) Pub. No.: US 2025/0048460 A1
(43) Pub. Date: Feb. 6, 2025

(54) METHOD FOR TRANSMITTING AND RECEIVING DATA IN SHORT-RANGE WIRELESS COMMUNICATION SYSTEM AND DEVICE THEREFOR

(71) Applicant: LG ELECTRONICS INC., Seoul (KR)

(72) Inventors: Hyeonjae LEE, Seoul (KR); Jongmin KIM, Seoul (KR); Minsoo LEE, Seoul (KR)

(73) Assignee: LG ELECTRONICS INC., Seoul (KR)

(21) Appl. No.: 18/690,163

(22) PCT Filed: Sep. 7, 2022
(86) PCT No.: PCT/KR2022/095121

§ 371 Date: Sep. 18, 2024

(30) Foreign Application Priority Data
Sep. 8, 2021 (KR) 10-2021-0119994
Sep. 9, 2021 (KR) 10-2021-0120573

(51) Int. Cl. H04W 76/14; H04W 56/00

(52) U.S. Cl. CPC H04W 76/14; H04W 56/001

(57) ABSTRACT

Provided are a method for transmitting and receiving data in a short-range wireless communication system, and a device therefor. More particularly, the method comprises the steps of: establishing a connection associated with a first channel for transmitting and receiving first data to and from a second device; establishing a connection associated with a second channel for transmitting and receiving second data, which is different from the first data, to and from the second device; transmitting and receiving, to and from the second device, the first data on the first channel on the basis of a first time interval for transmitting and receiving the first data on the first channel; and transmitting and receiving, to and from the second device, the second data on the second channel on the basis of a second time interval for transmitting and receiving the second data on the second channel, wherein the data transmission and reception on the first channel and the data transmission and reception on the second channel are performed on the basis of the transmission and reception timing of the first data at the first time interval and the transmission and reception timing of the second data at the second time interval.

### TECHNICAL FIELD

The present disclosure relates to a method of transmitting and receiving data using a short-range communication technology in a wireless communication system and a device therefor, and more particularly to a method of transmitting and receiving data using Bluetooth technology and a device therefor.

### BACKGROUND ART

Bluetooth is a short-range wireless technology standard that may wirelessly connect various types of devices and allows them to exchange data over short distances. To enable wireless communication between two devices using Bluetooth communication, a user has to perform the process of discovering Bluetooth devices to communicate with and making a connection request. As used herein, the term “device” refers to an appliance or equipment.

In this case, the user may discover a Bluetooth device according to a Bluetooth communication method intended to be used with the Bluetooth device using the Bluetooth device, and then perform a connection with the Bluetooth device.

The Bluetooth communication method may be divided into as a BR/EDR method and an LE method. The BR/EDR method may be called a Bluetooth Classic method. The Bluetooth Classic method includes a Bluetooth technology led from Bluetooth 1.0 and a Bluetooth technology using an enhanced data rate (EDR) supported by Bluetooth 2.0 or a subsequent version.

A BLE technology applied, starting from Bluetooth 4.0, may stably provide information of hundreds of kilobytes (KB) at low power consumption. Such a BLE technology allows devices to exchange information with each other using an attribute protocol. The BLE method may reduce energy consumption by reducing the overhead of a header and simplifying the operation.

Some of the Bluetooth devices do not have a display or a user interface. The complexity of a connection, management, control, and a disconnection between various Bluetooth devices and Bluetooth devices using similar technologies is increasing.

Bluetooth supports a high speed at a relatively low cost with relatively low power consumption. However, Bluetooth is appropriately used within a limited space because it has a maximum transmission distance of 100 m.

### DISCLOSURE

### Technical Problem

An object of the present disclosure is to provide a method of transmitting and receiving data in a short-range wireless communication system and a device therefor.

Another object of the present disclosure is to provide a method of transmitting and receiving data on two different channels and a device therefor.

Another object of the present disclosure is to provide a method of transmitting and receiving data when data transmission and reception timings on two different channels overlap, and a device therefor.

The technical objects to be achieved by the present disclosure are not limited to those that have been described hereinabove merely by way of example, and other technical objects that are not mentioned can be clearly understood by those skilled in the art, to which the present disclosure pertains, from the following descriptions.

### Technical Solution

The present disclosure provides a method of transmitting and receiving data in a short-range wireless communication system and a device therefor.

More specifically, a method of transmitting and receiving, by a first device, data in a short-range wireless communication system comprises forming, with a second device, a connection related to a first channel for transmitting and receiving first data; forming, with the second device, a connection related to a second channel for transmitting and receiving second data different from the first data; transmitting and receiving the first data with the second device on the first channel based on a first time interval in which the first data is transmitted and received on the first channel; and transmitting and receiving the second data with the second device on the second channel based on a second time interval in which the second data is transmitted and received on the second channel, wherein a data transmission and reception on the first channel and a data transmission and reception on the second channel are performed based on a transmission and reception timing of the first data in the first time interval and a transmission and reception timing of the second data in the second time interval.

Further, forming the connection related to the second channel may comprise transmitting, to the second device, information on a time offset from a start time of the first time interval to a start time of the second time interval. The second time interval may be configured based on the information on the time offset.

Based on the information on the time offset, the transmission and reception timing of the first data in the first time interval may be configured not to overlap the transmission and reception timing of the second data in the second time interval.

The data transmission and reception on the first channel may be performed between a time, at which the transmission and reception of the second data on the second channel in the second time interval is completed, and an end time of the second time interval. A length of the first time interval may be set to a multiple of the second time interval.

Based on the information on the time offset, the transmission and reception timing of the first data in the first time interval and the transmission and reception timing of the second data in the second time interval may be configured to overlap each other at least once.

At least one transmission and reception of the second data in the second time interval, that overlaps the transmission and reception timing of the first data in the first time interval, may be dropped. At least one transmission and reception of the first data in the first time interval, that overlaps the transmission and reception timing of the second data in the second time interval, may be performed.

The dropped at least one transmission and reception of the second data in the second time interval, that overlaps the transmission and reception timing of the first data in the first time interval, may be retransmitted in at least one next second time interval of the second time interval, that overlaps the transmission and reception timing of the first data in the first time interval.

The first device may be a central device, the second device may be a peripheral device, and the second data may be data generated based on a user input of the second device.

The first data may be null data, and the second data may be data requiring a low delay.

The present disclosure provides a first device transmitting and receiving data in a short-range wireless communication system. More specifically, the first device comprises a transmitter configured to transmit a radio signal, a receiver configured to receive the radio signal, at least one processor, and at least one computer memory operably connectable to the at least one processor. The at least one computer memory is configured to store instructions performing operations based on being executed by the at least one processor. The operations comprise forming, with a second device, a connection related to a first channel for transmitting and receiving first data; forming, with the second device, a connection related to a second channel for transmitting and receiving second data different from the first data; transmitting and receiving the first data with the second device on the first channel based on a first time interval in which the first data is transmitted and received on the first channel; and transmitting and receiving the second data with the second device on the second channel based on a second time interval in which the second data is transmitted and received on the second channel. A data transmission and reception on the first channel and a data transmission and reception on the second channel are performed based on a transmission and reception timing of the first data in the first time interval and a transmission and reception timing of the second data in the second time interval.

### Advantageous Effects

The present disclosure has an effect of transmitting and receiving data in a short-range wireless communication system.

The present disclosure has an effect of transmitting and receiving data on two different channels.

The present disclosure has an effect of transmitting and receiving data when data transmission and reception timings on two different channels overlap.

Effects that could be achieved with the present disclosure are not limited to those that have been described hereinabove merely by way of example, and other effects and advantages of the present disclosure will be more clearly understood from the following description by a person skilled in the art to which the present disclosure pertains.

### DESCRIPTION OF DRAWINGS

The accompanying drawings, which are included as part of the detailed description to aid understanding of the present disclosure, provide embodiments of the present disclosure and describe technical features of the present disclosure along with the detailed description.

FIG. 1 is a schematic view illustrating an example of a wireless communication system using a Bluetooth low energy technology to which the present disclosure is applicable.

FIG. 2 illustrates an example of an internal block diagram of a device capable of implementing methods described in the present disclosure.

FIG. 3 illustrates an example of Bluetooth communication architecture to which methods described in the present disclosure is applicable.

FIG. 4 illustrates an example of a structure of a generic attribute profile (GATT) of Bluetooth low energy.

FIG. 5 is a flowchart showing an example of a connection procedure method in Bluetooth low energy technology to which the present disclosure is applicable.

FIG. 6 illustrates an example of a packet format for data transmission.

FIG. 7 illustrates an example of a data physical channel PDU.

FIG. 8 illustrates an example of Bluetooth isochronous (ISO) architecture.

FIG. 9 illustrates an example of performing data transmission and reception between a master device and a slave device.

FIG. 10 illustrates another example of performing data transmission and reception between a master device and a slave device.

FIG. 11 illustrates another example of performing data transmission and reception between a master device and a slave device.

FIG. 12 illustrates another example of performing data transmission and reception between a master device and a slave device.

FIG. 13 illustrates another example of performing data transmission and reception between a master device and a slave device.

FIG. 14 illustrates another example of performing data transmission and reception between a master device and a slave device.

FIG. 15 illustrates another example of performing data transmission and reception between a master device and a slave device.

FIG. 16 is a flowchart illustrating an example of performing a method described in the present disclosure.

FIG. 17 illustrates another example of Bluetooth isochronous (ISO) architecture.

FIG. 18 illustrates another example of data transmission and reception on ISO channel.

FIG. 19 illustrates an example of performing data transmission and reception between a master device and a slave device.

FIG. 20 illustrates an example of performing data transmission and reception between a master device and a slave device.

FIG. 21 illustrates an example of performing data transmission and reception between a master device and a slave device.

FIG. 22 illustrates another example of performing data transmission and reception between a master device and a slave device.

FIG. 23 is a flowchart illustrating an example where a method of transmitting and receiving data in a short-range wireless communication system described in the present disclosure is performed by a first device.

### MODE FOR INVENTION

In order to help understanding of the present disclosure, the accompanying drawings which are included as a part of the Detailed Description provide embodiments of the present disclosure and describe the technical features of the present disclosure together with the Detailed Description. Like reference numerals principally designate like elements throughout the disclosure. Further, in describing the present disclosure, a detailed explanation of known related technologies may be omitted to avoid unnecessarily obscuring the subject matter of the present disclosure. Further, it is noted that the accompanying drawings are only for easily understanding the spirit of the present disclosure and it should not be interpreted that the spirit of the present disclosure is limited by the accompanying drawings.

Hereinafter, a method and an apparatus related with the present disclosure will be described in more detail with reference to drawings. In addition, a general term used in the present disclosure should be interpreted as defined in a dictionary or contextually, and should not be interpreted as an excessively reduced meaning. Further, a singular form used in the present disclosure may include a plural form if there is no clearly opposite meaning in the context. In the present application, a term such as “comprising” or “including” should not be interpreted as necessarily including all various components or various steps disclosed in the disclosure, and it should be interpreted that some component or some steps among them may not be included or additional components or steps may be further included. Suffixes “unit”, “module”, and “section” for components used in the following description are given or mixed in consideration of easy preparation of the disclosure only and do not have their own distinguished meanings or roles. The terms “first”, “second”, and the like are used to differentiate a certain component from other components, but the scope of should not be construed to be limited by the terms.

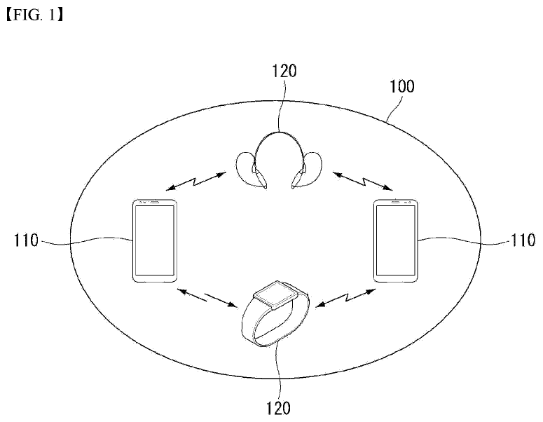

FIG. 1 is a schematic view illustrating an example of a wireless communication system using a Bluetooth low energy technology to which the present disclosure is applicable.

A wireless communication system 100 includes at least one server device 120 and at least one client device 110.

The server device and the client device perform Bluetooth communication using a Bluetooth low energy (BLE) technology.

First, compared with a Bluetooth basic rate/enhanced data rate (BR/EDR), the BLE technology has a relatively small duty cycle, may be produced at low cost, and significantly reduce power consumption through a low data rate, and thus, it may operate a year or longer when a coin cell battery is used.

Also, in the BLE technology, an inter-device connection procedure is simplified and a packet size is designed to be small compared with the Bluetooth BR/EDR technology.

In the BLE technology, (1) the number of RF channels is forty, (2) a data rate supports 1 Mbps, (3) topology has a scatternet structure, (4) latency is 3 ms, (5) a maximum current is 15 mA or lower, (6) output power is 10 mW (10 dBm) or less, and (7) the BLE technology is commonly used in applications such as a clock, sports, healthcare, sensors, device control, and the like.

The server device 120 may operate as a client device in a relationship with other device, and the client device may operate as a server device in a relationship with other device. That is, in the BLE communication system, any one device may operate as a server device or a client device, or may operate as both a server device and a client device if necessary.

The server device 120 may be expressed as a data service device, a slave device, a slave, a server, a conductor, a host device, a gateway, a sensing device, a monitoring device, a first device, a second device, etc.

The client device 110 may be expressed as a master device, a master, a client, a member, a sensor device, a sink device, a collector, a third device, a fourth device, etc.

The server device and the client device correspond to main components of the wireless communication system and the wireless communication system may include other components other than the server device and the client device.

The server device refers to a device that receives data from the client device, communicates directly with the client device, and provides data to the client device through a response when receiving a data request from the client device.

Further, the server device sends a notice/notification message and an indication message to the client device in order to provide data information to the client device. In addition, when the server device transmits the indication message to the client device, the server device receives a confirm message corresponding to the indication message from the client device.

Further, the server device may provide the data information to a user through a display unit or receive a request input from the user through a user input interface in the process of transmitting and receiving the notice, indication, and confirm messages to and from the client device.

In addition, the server device may read data from a memory unit or write new data in the corresponding memory unit in the process of transmitting and receiving the message to and from the client device.

Further, one server device may be connected to multiple client devices and may be easily reconnected to the client devices by using bonding information.

The client device 120 refers to a device that requests the data information or data transmission to the server device.

The client device receives the data from the server device through the notice message, the indication message, etc., and when receiving the indication message from the server device, the client device sends the confirm message in response to the indication message.

Similarly, the client device may also provide information to the user through the display unit or receive an input from the user through the user input interface in the process of transmitting and receiving the messages to and from the server device.

In addition, the client device may read data from the memory unit or write new data in the corresponding memory unit in the process of transmitting and receiving the message to and from the server device.

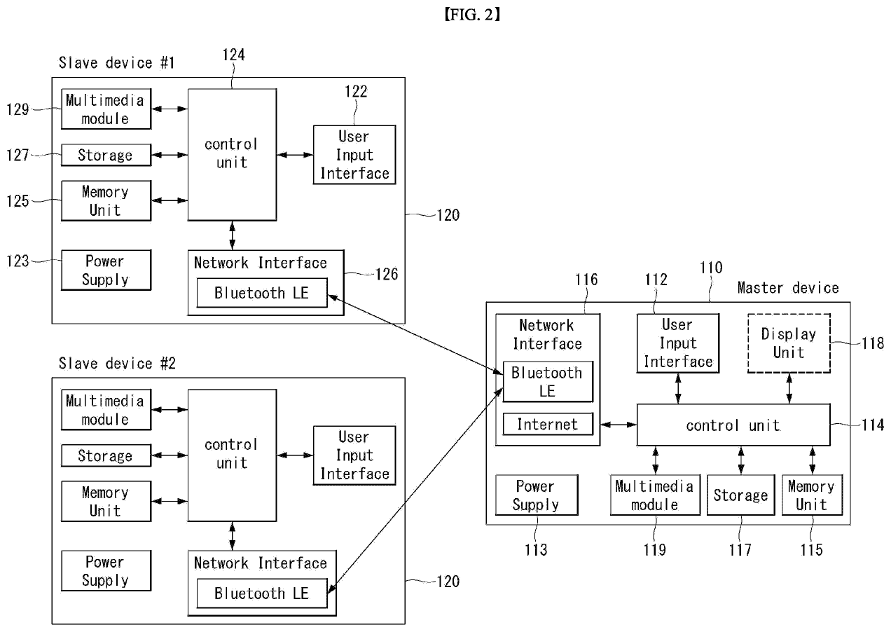

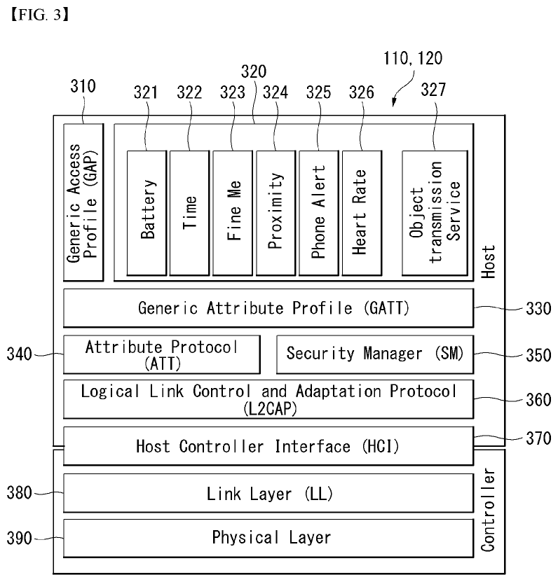

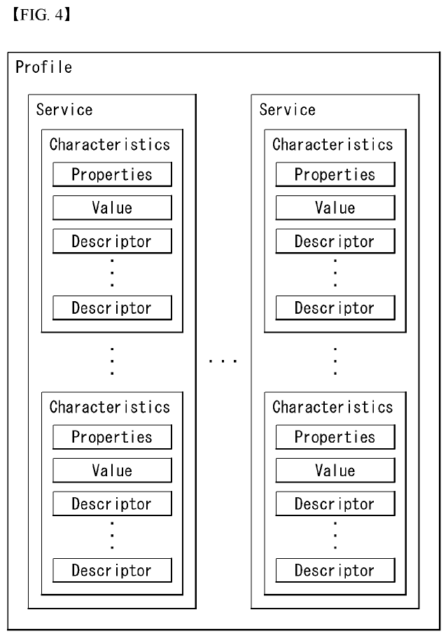

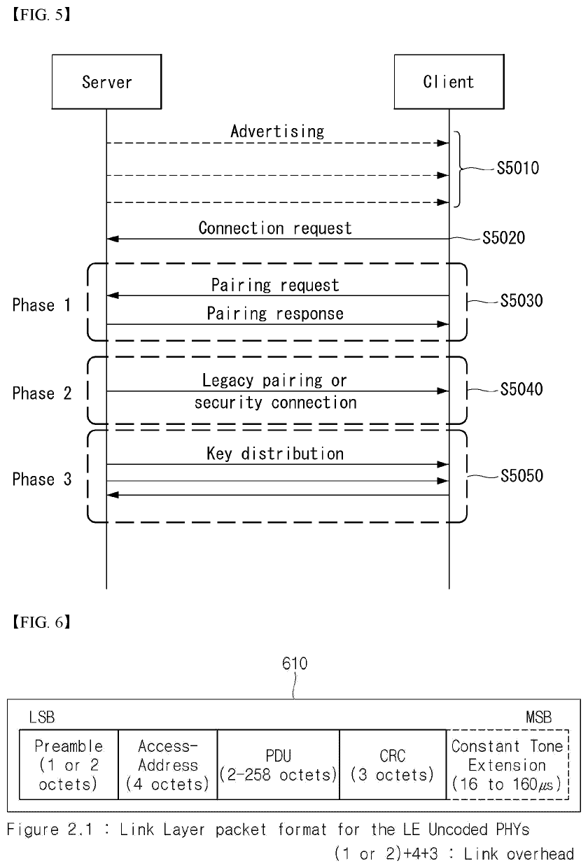

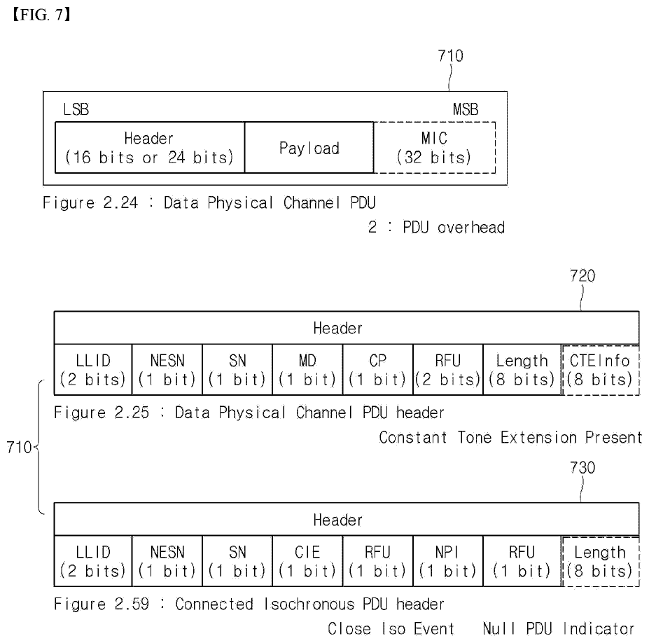

Hardware components such as the display unit, the user input interface, and the memory unit of the server device and the client device will be described in detail in FIG. 2.

Further, the wireless communication system may configure personal area networking (PAN) through Bluetooth technology. As an example, in the wireless communication system, a private piconet between the devices is established to rapidly and safely exchange files, documents, and the like.

FIG. 2 illustrates an example of an internal block diagram of a device capable of implementing methods described in the present disclosure.

As illustrated in FIG. 2, the master device 110 includes a user input interface 112, a power supply unit 113, a control unit 114, a memory unit 115, a network interface 116 including a Bluetooth interface, a storage 117, a display unit 118, and a multimedia module 119.

The user input interface 112, the power supply unit 113, the control unit 114, the memory unit 115, the network interface 116 including the Bluetooth interface, the storage 117, the display unit 118, and the multimedia module 119 are functionally connected to each other to perform methods described in the present disclosure.

Further, as illustrated in FIG. 2, a slave device (#1 and #2) 120 includes a user input interface 122, a power supply unit 123, a control unit 124, a memory unit 125, a network interface 126 including a Bluetooth interface, a storage 127, a display unit 128, and a multimedia module 129.

The user input interface 122, the power supply unit 123, the control unit 124, the memory unit 125, the network interface 126 including the Bluetooth interface, the storage 127, the display unit 128, and the multimedia module 129 are functionally connected to each other to perform methods described in the present disclosure.

The network interfaces 116 and 126 refer to units (or modules) capable of transmitting requests/responses, commands, notifications, indication/confirmation messages, etc., or data between devices using Bluetooth technology.

The memory units 115 and 125 refer to units implemented in various types of devices and refer to units in which various types of data are stored. The storages 117 and 127 refer to units that perform a function similar to a function of a memory.

The control units 114 and 124 refer to modules that control the overall operation of the master device 110 or the slave device 120, and request to transmit a message to the network interface or control to process a received message.

The control units 114 and 124 may include an application-specific integrated circuit (ASIC), another chipset, a logic circuit, and/or a data processing device.

The memory units 115 and 125 may include a read-only memory (ROM), a random access memory (RAM), a flash memory, a memory card, a storage medium, and/or other storage devices.

The memory units 115 and 125 may be inside or outside the processors 114 and 124 and may be connected to the processors 114 and 124 by various well-known means.

The display units 118 and 128 refer to modules for providing status information and message exchange information of the device to a user through a screen.

The power supply units 113 and 123 refers to modules that receive external power and internal power under the control of the control unit and supply power necessary for the operation of each component.

As discussed above, the BLE technology has a small duty cycle and can greatly reduce power consumption through a low data transfer rate.

FIG. 3 illustrates an example of Bluetooth communication architecture to which methods described in the present disclosure is applicable.

Specifically, FIG. 3 illustrates an example of architecture of Bluetooth low energy (LE).

As illustrated in FIG. 3, the BLE structure includes a controller stack capable of processing a wireless device interface for which timing is critical and a host stack capable of processing high level data.

The controller stack may also be called a controller. In order to avoid confusion with the processor, that is, an internal element of the device described with reference to FIG. 2, however, the controller stack may be preferably used below.

First, the controller stack may be implemented using a communication module which may include a Bluetooth wireless device and a processor module which may include a processing device, such as a microprocessor.

The host stack may be implemented as part of an OS operating on the processor module or as a package instance on an OS.

In some cases, the controller stack and the host stack may operate or may be performed on the same processing device within the processor module.

The host stack includes a generic access profile (GAP) 310, GATT based profiles 320, a generic attribute profile (GATT) 330, an attribute protocol (ATT) 340, a security manager (SM) 350, and a logical link control and adaptation protocol (L2CAP) 360. The host stack is not limited to the aforementioned composition, but may include various protocols and profiles.

The host stack multiplexes various protocols and profiles provided by that Bluetooth disclosure using the L2CAP.

First, the L2CAP 360 provides one bilateral channel for sending data to according to a specific protocol or specific profile.

The L2CAP is capable of multiplexing data between upper layer protocols, segmenting or reassembling packages, and managing multicast data transmission.

BLE uses three fixed channels for respective signaling, a security manager, and an attribute protocol.

BR/EDR uses a dynamic channel and supports a protocol service multiplexer, retransmission, streaming mode.

The SM 350 authenticates a device, which is a protocol for providing a key distribution.

The ATT 340 relies on a server-client structure, which defines rules for a corresponding device for data access. Six message types are defined: Request, Response, Command, Notification, Indication, and Confirmation.

\textcircled{1} Request and Response message: the Request message is used when a client device requests specific information from a server device, and the Response message is used in response to a Request message, which is transmitted from the server device to the client device.

\textcircled{2} Command message: The Command message is transmitted from a client device to a server device in order to indicate a command for a specific operation, but the server device does not send a response to a Command message to the client device.

\textcircled{3} Notification message: A server device sends this message to a client device in order to provide notification of an event, but the client device does not send a confirmation message to the server device in response to a Notification message.

\textcircled{4} Indication and Confirm message: A server device sends this message to a client device in order to provide notification of an event. Unlike in the Notification message, the client device sends a Confirm message to the server device in response to an Indication message.

The generic access profile (GAP) is a layer newly implemented to support the BLE technology, and is used to control the selection of a role for communication between BLE devices and a multi-profile operation.

The GAP is mainly used for device discovery, connection establishment, and security. That is, the GAP defines a method for providing information to a user and also defines the following attribute types.

\textcircled{1} Service: A combination of actions related to data, and it defines the basic operation of a device.

\textcircled{2} Include: Define a relationship between services.

\textcircled{3} Characteristics: A data value used by a service

\textcircled{4} Behavior: A format that may be readable by a computer, which is defined by a Universal Unique Identifier (UUID) and a value type.

The GATT-based profiles are dependent on the GATT and are mainly applied to BLE devices. The GATT-based profiles may include Battery, Time, FindMe, Proximity, Object Delivery Service and so on. More specific descriptions of the GATT-based profiles are as follows.

Battery: A method for exchanging battery information.

Time: A method for exchanging time information.

FindMe: A method for providing an alarm service according to the distance.

Proximity: A method for exchanging battery information.

Time: A method for exchanging time information

The GATT may be used as a protocol by which to describe how the ATT is utilized at the time of composing services. For example, the GATT may be used to define how the ATT profiles are grouped together with services and to describe characteristics associated with the services.

Therefore, the GATT and the ATT describe device statuses and services, and how features are associated with each other and how they are used.

The controller stack includes a physical layer 390, a link layer 380, and a host controller interface 370.

The physical layer 390 (or a wireless transmission and reception module) sends and receives radio signals of 2.4 GHz, and uses GFSK modulation and frequency hopping utilizing 40 RF channels.

The link layer 380 sends or receives Bluetooth packets.

Furthermore, the link layer establishes a connection between devices after performing the advertising and scanning function using three advertising channels, and provides a function of exchanging a maximum of 42 bytes of data packets through 37 data channels.

The host controller interface (HCI) provides an interface between the host stack and the controller stack so that the host stack may provide commands and data to the controller stack and the controller stack may provide events and data to the host stack.

Hereinafter, the procedure of BLE is described briefly.

The BLE procedure includes a device filtering procedure, an advertising procedure, a scanning procedure, a discovering procedure, and a connecting procedure.

### Device Filtering Procedure

The device filtering procedure functions to reduce the number of devices which perform responses to requests, commands, or notification in the controller stack.

All of devices may not need to respond to received requests. Accordingly, the controller stack reduces the number of transmitted requests so that power consumption may be reduced in the BLE controller stack.

An advertising device or a scanning device may perform the device filtering procedure in order to restrict the number of devices which receive advertisement packets, scan requests, or connection requests.

In this case, the advertising device refers to a device which sends an advertisement event, that is, a device which performs advertisement, and is also called an advertiser.

A scanning device refers to a device which performs scanning, that is, a device which sends a scan request.

In the BLE disclosure, if a scanning device receives part of advertisement packets from an advertising device, the scanning device has to send a scan request to the advertising device.

If the transmission of a scan request is not required as the device filtering procedure is used, however, the scanning device may ignore advertisement packets transmitted by an advertising device.

The device filtering procedure may be used even in the connection request procedure.

If device filtering is used for the connection request procedure, the need for sending a response to a connection request may be made unnecessary by ignoring the connection request.

### Advertising Procedure

An advertising device performs an advertisement procedure to perform non-directional broadcast using the devices within the range of the advertising device.

In this case, the non-directional broadcast refers to broadcast in all directions rather than broadcast in specific directions.

Unlike the non-directional broadcast, the directional broadcast refers to broadcast in a specific direction. Non-directional broadcast is performed without involving a connection procedure between devices in a listening state (hereinafter referred to as a “listening device”).

The advertising procedure is used to establish a BLE to a nearby initiating device.

In some embodiments, the advertising procedure may be used to provide the periodic broadcast of user data to scanning devices which perform listening through an advertising channel.

In the advertising procedure, all of advertisements (or advertisement events) are broadcasted through an advertising physical channel.

An advertising device may receive a scan request from a listening device which performs a listening operation in order to obtain additional user data from the advertising device. In response to the scan request, the advertising device sends a response to the listening device which has sent the scan request through the same advertising physical channel through which the advertising device has received the scan request.

While broadcast user data sent as part of advertising packets forms dynamic data, scan response data is static for the most part.

An advertising device may receive a connection request from an initiating device through an advertising (or broadcast) physical channel. If the advertising device has used a connectable advertisement event and the initiating device has not been filtered by a filtering procedure, the advertising device stops an advertisement and enters connected mode. The advertising device may resume the advertisement after entering the connected mode.

### Scanning Procedure

A device performing a scan operation, that is, a scanning device, performs a scanning procedure in order to listen to the non-directional broadcast of user data from advertising devices which use an advertising physical channel.

In order to request additional user data, a scanning device sends a scan request to an advertising device through an advertising physical channel. In response to the scan request, the advertising device includes additional user data requested by the scanning device in a scan response and sends the scan response to the scanning device through the advertising physical channel.

The scanning procedure may be used while a scanning device is connected to another BLE device in a BLE piconet.

If a scanning device receives a broadcast advertising event and stays in initiator mode where a connection request may be initiated, the scanning device may initiate BLE for an advertising device by sending a connection request to the advertising device through an advertising physical channel.

If a scanning device sends a connection request to an advertising device, the scanning device stops the entire scanning for additional broadcast and enters connected mode.

### Discovering Procedure

Devices capable of Bluetooth communication (hereinafter referred to as “Bluetooth devices”) perform an advertising procedure and a scanning procedure in order to discover devices around the Bluetooth devices or devices to be discovered by other devices within a given area.

The discovering procedure is performed in an asymmetric manner. A Bluetooth device searching for another Bluetooth device nearby is called a discovering device, and performs listening in order to search for devices that advertise advertisement events that may be scanned. A Bluetooth device which may be discovered and used by another device is called a discoverable device. A discoverable device actively broadcasts an advertisement event so that other devices may scan the discoverable device through an advertising (or broadcast) physical channel.

Both of the discovering device and the discoverable device may already have been connected to other Bluetooth devices in a piconet

### Connecting Procedure

A connecting procedure is asymmetric. In the connecting procedure, while a particular Bluetooth device performs an advertising procedure, other Bluetooth devices need to perform a scanning procedure.

In other words, the advertising procedure may be a primary task to be performed, and as a result, only one device may respond to an advertisement. After receiving a connectable advertisement event from an advertising device, the connecting procedure may be initiated by sending a connection request to the advertising device through an advertising (or broadcast) physical channel.

Operation statuses defined in the BLE technology, that is, an advertising state, a scanning state, an initiating state, and a connection state, are described briefly below.

### Advertising State

The link layer (LL) enters the advertising state in a command from a host (or stack). If the link layer is in the advertising state, the link layer sends advertising packet data units (PDUs) at advertisement events.

Each advertisement event includes at least one advertising PDU, and the advertising PDU is transmitted through an advertising channel index. Each advertisement event may be previously closed if the advertising PDU is transmitted through each advertising channel index, the advertising PDU is terminated, or the advertising device needs to secure the space in order to perform other functions.

### Scanning State

The link layer enters the scanning state in response to a command from a host (or stack). In the scanning state, the link layer listens to advertising channel indices.

The scanning state supports two types: passive and active scanning. The host determines a scanning type.

No separate time or advertising channel index is defined to perform scanning.

In the scanning state, the link layer listens to an advertising channel index for “scanWindow” duration. scanInterval is defined as the interval between the start points of two consecutive scan windows.

If there is no scheduling collision, the link layer has to perform listening in order to complete all of the scanIntervals of scanWindows as commanded by the host. In each scanWindow, the link layer has to scan other advertising channel indices. The link layer uses all of available advertising channel indices.

In the case of passive scanning, the link layer is unable to send any packet, but only receives packets.

In the case of active scanning, the link layer performs listening to the advertising device to rely on the advertising PDU type by which additional information related to the advertising PDUs and advertising device may be requested.

### Initiating State

The link layer enters the initiating state in response to a command from a host (or stack).

In the initiating state, the link layer performs listening to advertising channel indices.

In the initiating state, the link layer listens to an advertising channel index for “scanWindow” duration.

### Connection State

The link layer enters a connection state when the device performing the connection request, i. E., the initiating device transmits CONNECT_REQ PDU to the advertising device or when the advertising device receives CONNECT_REQ PDU from the initiating device.

After entering the connections state, it is considered that the connection is created. However, it need not be considered so that the connection is established at the time of entering the connections state. An only difference between a newly created connection and the previously established connection is a link layer connection supervision timeout value.

When two devices are connected to each other, two devices play difference roles.

A link layer serving as a master is referred to as the master and a link layer serving as a slave is referred to as the slave. The master controls a timing of a connection event and the connection event refers to a time at which the master and the slave are synchronized.

Hereinafter, a packet defined the Bluetooth interface will be briefly described. BLE devices use packets defined below.

### Packet Format

The link layer has only one packet format used for both an advertising channel packet and a data channel packet.

Each packet is constituted by four fields, i.e., a preamble, an access address, a PDU, and a CRC.

When one packet is transmitted in an advertising physical channel, the PDU will become an advertising channel PDU and when one packet is transmitted in a data physical channel, the PDU will become a data channel PDU.

### Advertising Channel PDU

The advertising channel PDU includes a 16 bit header and a payload of various sizes.

The PDU type field of an advertising channel included in the header supports PDU types defined in Table 1 below.

TABLE 1

| | | | Permitted PHYs | | |
|---|---|---|---|---|---|
| PDU | PDU | | LE | LE | LE |
| Type | Name | Channel | 1M | 2M | Coded |
| 0000b | ADV_IND | Primary | ● | | |
| | | Advertising | | | |
| 0001b | ADV_DIRECT_IND | Primary | ● | | |
| | | Advertising | | | |
| 0010b | ADV_NONCONN_IND | Primary | ● | | |
| | | Advertising | | | |
| 0011b | SCAN_REQ | Primary | ● | | |
| | | Advertising | | | |
| | AUX_SCAN_REQ | Secondary | ● | ● | ● |
| | | Advertising | | | |
| 0100b | SCAN_RSP | Primary | ● | | |
| | | Advertising | | | |
| 0101b | CONNECT_IND | Primary | ● | | |
| | | Advertising | | | |
| | AUX_CONNECT_REQ | Secondary | ● | ● | ● |
| | | Advertising | | | |
| 0110b | ADV_SCAN_IND | Primary | ● | | |
| | | Advertising | | | |

### Advertising PDU

The following advertising channel PDU types are called advertising PDUs and are used for specific events.

ADV_IND: a connectable non-directional advertisement event

ADV_DIREC_IND: a connectable directional advertisement event

ADV_NONCONN_IND: a non-connectable non-directional advertisement event

ADV_SCAN_IND: a non-directional advertisement event that may be scanned

The PDUs are transmitted by the link layer in the advertising state and are received by the link layer in the scanning state or initiating state.

### Scanning PDUs

The advertising channel PDU type below is called a scanning PDU and is used in the status described below.

SCAN_REQ: transmitted by the link layer in the scanning state and received by the link layer in the advertising state.

SCAN_RSP: transmitted by the link layer in the advertising state and received by the link layer in the scanning state.

### Initiating PDUs

The advertising channel PDU type below is called an initiating PDU.

CONNECT_REQ: transmitted by the link layer in the initiating state and received by the link layer in the advertising state.

### Data Channel PDU

The data channel PDU may have a 16-bit header and various sizes of payloads and include a message integrity check (MIC) field.

The procedure, the state, the packet format, and the like in the BLE technology, which are described above, may be applied in order to perform methods proposed by the present disclosure.

FIG. 4 illustrates an example of a structure of a generic attribute profile (GATT) of Bluetooth low energy.

Referring to FIG. 4, a structure for exchanging profile data of the Bluetooth low energy may be described.

Specifically, the generic attribute profile (GATT) is a definition of a method in which data is transmitted and received by using services and characteristics between the Bluetooth LE devices.

In general, a Peripheral device (e.g., a sensor device) serves as a GATT server and has a definition of services and characteristics.

A GATT client sends a data request to the GATT server in order to read or write the data and all transactions start at the GATT client and the response is received from the GATT server.

A GATT-based operation structure used in the Bluetooth LE may be based on THE profile, the service, and the characteristic, and may have a vertical structure illustrated in FIG. 4.

The profile may be constituted by one or more services and the service may be constituted by one or more characteristics or other services.

The service may serve to divide data into logical units and include one or more characteristics or other services. Each service has a 16-bit or 128-bit separator called a Universal Unique Identifier (UUID).

The characteristic is a lowest unit in the GATT-based operation structure. The characteristic includes only one datum and has a 16-bit or 128-bit UUID similar to the service.

The characteristic is defined as a value of various information and requires one attribute to contain each information. The characteristic may adopt various consecutive attributes.

The attribute is constituted by four components, which have the following meanings.
handle: Address of attribute
Type: Type of attribute
Value: Value of attribute
Permission: Access authority to attribute

FIG. 5 is a flowchart showing an example of a connection procedure method in Bluetooth low energy technology to which the present disclosure may be applied.

A server transmits to a client an advertisement message through three advertising channels (S5010).

The server may be called an advertiser before connection and called as a master after the connection. As an example of the server, there may be a sensor (temperature sensor, etc.).

Further, the server may be called a scanner before the connection and called as a slave after the connection. As an example of the client, there may be a smartphone, etc.

As described above, in Bluetooth, communication is performed over a total of 40 channels through the 2.4 GHz band. Three channels among 40 channels as the advertising channels are used for exchanging sent and received for establishing the connection, which include various advertising packets.

The remaining 37 channels are used for data exchange after connection to the data channel.

The client may receive the advertisement message and thereafter, transmit the Scan Request message to the server in order to obtain additional data (e.g., a server device name, etc.).

In this case, the server transmits the Scan Response message including the additional data to the client in response to the Scan Request message.

Here, the Scan Request message and the Scan Response message are one type of advertising packet and the advertising packet may include only user data of 31 bytes or less.

Therefore, when there is data in which the size of the data is larger than 3 bytes, but overhead to transmit the data through the connection, the data is divided and sent twice by using the Scan Request message and the Scan Response message.

Next, the client transmits to the server a Connection Request message for establishing a Bluetooth connection with the server (S5020).

Therefore, a Link Layer (LL) connection is established between the server and the client.

Thereafter, the server and the client perform a security establishment procedure.

The security establishment procedure may be interpreted as security simple pairing or may be performed including the same.

That is, the security establishment procedure may be performed through Phase 1 through Phase 3.

Specifically, a pairing procedure (Phase 1) is performed between the server and the client (55030).

In the pairing procedure, the client transmits a Pairing Request message to the server and the server transmits a Pairing Response message to the client.

Through the pairing procedure, authentication requirements and input (I)/output (O) capabilities and Key Size information are sent and received between the devices. Through the information, which key generation method is to be used in Phase 2 is determined.

Next, as Phase 2, legacy pairing or secure connections are performed between the server and the client (S5040).

In Phase 2, A 128-bit temporary key and a 128-bit short term key (STK) for performing the legacy pairing are generated.
Temporary Key: Key made for creating the STK
Short Term Key (LTK): Key value used for making encrypted connection between devices

When the secure connection is performed in Phase 2, a 128-bit long term key (LTK) is generated.

Long Term Key (LTK): Key value used even in later connection in addition to encrypted connection between the devices

Next, as Phase 3, a Key Distribution procedure is performed between the server and the client (S5050).

Therefore, the secure connection may be established and the data may be transmitted and received by forming the encrypted link.

### General of Isochronous Channel

With respect to an audio signal, audio streaming data or audio data may be periodically generated at an idle event interval.

The audio data is generated periodically (or at a specific time interval) based on characteristics thereof. The specific time interval at which the audio data is periodically generated may be expressed as the idle event interval. Each audio data is transmitted at each idle event interval. Further, each audio data may be transmitted in an entire duration or a partial duration of the idle event interval. When the audio streaming data generated periodically or regularly is transmitted using a BLE mechanism, an advertising and scanning procedure, a communication procedure, a disconnection procedure, etc. should be performed each time the generated audio data is transmitted/received. However, the audio data is generally periodically generated, and latency guarantee for audio data transmission is required regardless of an amount of the audio data.

However, when the advertising and scanning procedure, the communication procedure, the disconnection procedure, etc. should be performed each time newly generated audio data is transmitted, there is a problem in that latency occurs in audio data transmission.

Because the audio data transmission through hearing aids (HA) or headset, etc. has a comparatively small amount of data generated, it can obtain higher energy efficiency when using the BLE technology rather than the Bluetooth BR/EDR technology. However, as described above, because a data channel process of the BLE technology should perform advertising, connection, etc., every data transmission, the data transmission has large overhead, and in particular, latency guarantee absolutely required for the audio data transmission cannot be guaranteed.

Further, since the data channel process of the BLE technology transmits isolatedly generated data only as necessary, and has a purpose of increasing energy efficiency by inducing a deep sleep of the BLE device in other time domains. Therefore, it may be difficult to apply the data channel process of the BLE technology to transmission of periodically generated audio data.

### Definition of Isochronous Channel and Mechanism Related Thereto

A new channel, i.e., an isochronous channel is defined to transmit periodically generated data using the BLE technology.

The isochronous channel is a channel used for transmitting isochronous data between devices (e.g., conductor-member) using an isochronous stream.

The isochronous data refers to data transmitted at a specific time interval, i.e., periodically or regularly.

That is, the isochronous channel may represent a channel in which the periodically generated data such as audio data or voice data is transmitted/received in the BLE technology. Further, the isochronous channel may represent a channel on which data generated based on a user input of a game user's controller device is transmitted and received in a gaming scenario. The isochronous channel may be used for transmitting/receiving the audio data to/from a single member, a set of one or more coordinated members, or multiple members. Further, the isochronous channel corresponds to a flushing channel which may be used for transmitting/receiving key data in an isochronous stream such as an audio streaming or other time domains.

The present disclosure proposes a method of setting data transmission timing on different channels formed between a master device and a slave device. More specifically, the different channels may include two channels. In this instance, one channel may be a channel based on asynchronous connection-less (ACL) connection, and the other channel may be a channel based on isochronous (ISO) connection.

FIG. 6 illustrates an example of a packet format for data transmission. A packet format of FIG. 6 relates to a link layer packet format for low power Uncoded PHYs. Referring to FIG. 6, the packet format may include a preamble, access-address, a packet data unit (PDU), and CRC, and may further include a constant tone extension field.

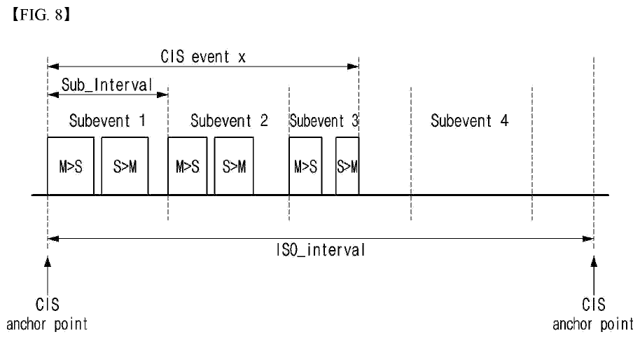

FIG. 7 illustrates an example of a data physical channel PDU. Referring to FIG. 7, a data physical channel PDU 710 may include a header and a payload and may further include MIC. In this instance, the header may include a header 720 in which a constant tone extension field is present and a connected isochronous PDU header 730 in which the constant tone extension field is not present.

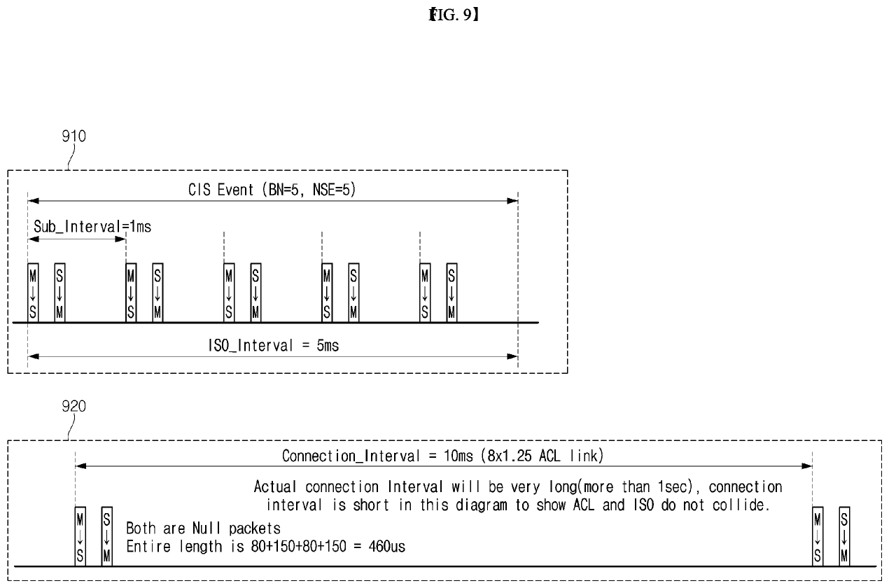

FIG. 8 illustrates an example of Bluetooth isochronous (ISO) architecture.

It can be seen from FIG. 8 that data transmission and reception between a master device and a slave device (or a source device or a sink device) through a CIS channel is performed within ISO_interval. In this instance, the ISO_interval may include at least one sub-event, and data transmission from the master device to the slave device and data transmission from the slave device to the master device may be performed within one sub-event.

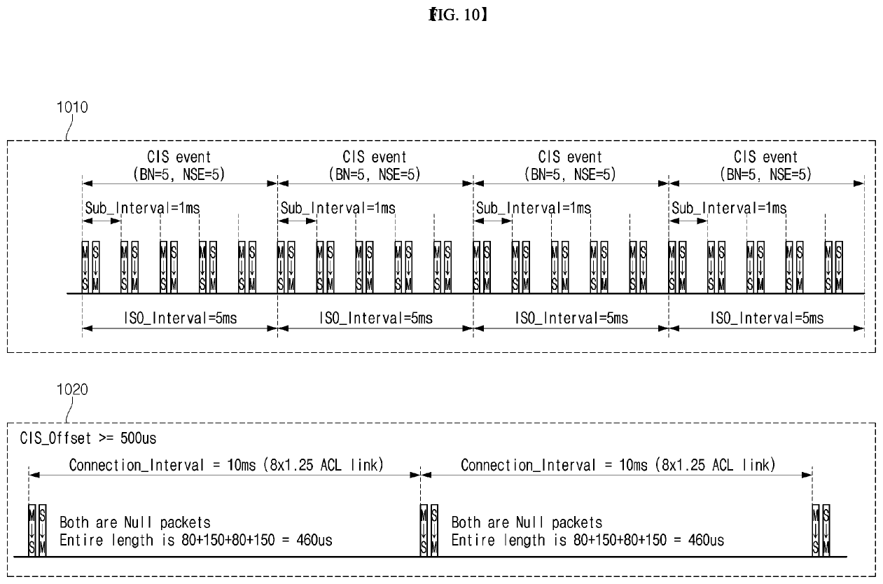

FIG. 9 illustrates an example of performing data transmission and reception between a master device and a slave device.

In FIG. 9, a reference numeral 910 denotes a CIS channel formed between a master device and a slave device, and a reference numeral 920 denotes an ACL channel formed between the master device and the slave device. A procedure performed between the master device and the slave device to form the CIS channel may be performed based on the ACL channel. That is, the master device and the slave device may perform a setup procedure for forming a CIS connection on the ACL channel, after forming the ACL channel. In the reference numeral 920 of FIG. 9, the ACL channel may assume a channel in which a connection interval is 10 ms, and an actual connection interval of the ACL channel may be more than 1 second. In the connection interval, the master device may transmit a poll (null packet) to the slave device. In this instance, the slave device may transit data to the master device as a response to the poll. In the present disclosure, the ACL channel may be called a first channel, and the ISO channel may be called a second channel. In FIG. 9, settings for the data transmission and reception may be as follows.

$$Packet = Preamble ( 1 byte ) + AccessAddress ( 4 byte ) + PSU + CRC ( 3 byte ) \\ PDU = Header ( 2 ) + Payload ( 0 ∼ 251 ) byte \\ Header = LLID , NESN , SN , CIE , RFU , NPI , RFU + Len ( 1 byte )$$

Overhead to Payload is 10 byte (80 bit, 80 us)

M->SNull packet (Poll), Packet time=80 us

S->M:Payload (Mouse)=4 byte, Packet time=80 us+32 us=112 us

$$Minimum SE\_Length = M -> S + T\_IFS + S -> M + T\_MSS = 80 + 150 + 112 + 1 \; 50 = 492 us$$

In the reference numeral 910 of FIG. 9, a CSI channel may assume a channel in which an ISO interval is 5 ms, and one ISO interval may include five sub-intervals. In one sub-interval, the master device transmits data to the slave device, and then the slave device transmits data to the master device. In this instance, when a gaming service is provided, the slave device may be a user's game controller, and the data transmitted from the slave device to the master device may be data generated based on a user input.

In FIG. 9, if a size of data transmitted within a sub-interval is small and a sub-event ends quickly, an available time duration is present in an end portion of the sub-interval. In this instance, because ACL connection shall be associated with ISO connection (create, disconnect, setting change), the ACL connection needs to be maintained during the ISO connection. In this instance, in order to maintain 1 ms interval of ultra-low latency (ULL) of the ISO connection and at the same time maintain the ACL connection, the ACL packets are arranged at a connection interval in the remaining portion of the sub-interval.

The data transmission and reception on the ACL channel and the data transmission and reception on the ISO channel may be performed based on data transmission and reception timing on the ACL channel and data transmission and reception timing on the ISO channel. FIG. 9 illustrates an example where the data transmission and reception timing on the ACL channel and the data transmission and reception timing on the ISO channel are set so that the data transmission and reception timing on the ACL channel does not overlap the data transmission and reception timing on the ISO channel. If the connection interval of the ACL channel is set to a multiple of the sub-interval, a collision between the data transmission and reception timing on the ACL channel and the data transmission and reception timing on the ISO channel may not occur.

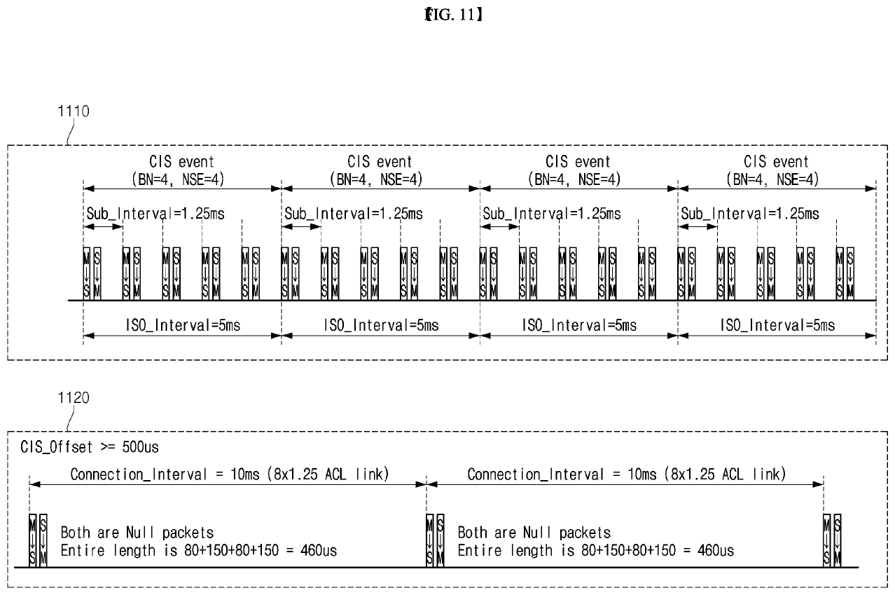

FIG. 10 illustrates another example of performing data transmission and reception between a master device and a slave device. More specifically, FIG. 10 illustrates an example where a plurality of ISO intervals and a plurality of connection intervals are repeated, unlike FIG. 9 illustrating one ISO interval and one connection interval. In FIG. 10, a sub-interval is 1 ms. In particular, FIG. 10 illustrates that when a connection interval of an ACL channel is set to a multiple of the sub-interval, a collision between data transmission and reception timing on the ACL channel and data transmission and reception timing on the ISO channel does not occur.

If Sub_Interval is 1 ms, Connection_Interval such as 10 ms, 15 ms, 20 ms, . . . may be used. Further, if the Sub_Interval is 2 ms, the Connection_Interval such as 10 ms, 20 ms, 30 ms, 40 ms, 60 ms, . . . may be used.

Further, if the Sub_Interval is 4 ms, the Connection_Interval such as 20 ms, 40 ms, 60 ms, 80 ms, 120 ms, . . . may be used. The master device and the slave device may form ISO connection using LL_CIS_REQ, LL_CIS_RSP, and LL_CIS_IND packets through ACL connection. The time until a first anchor point of the ISO channel after the LL_CIS_IND packet is referred to as CIS_Offset, and the CIS_Offset may be set arbitrarily. When a collision between a first ISO interval and a connection interval does not occur by setting an appropriate CIS_Offset value, if the connection interval of the ACL channel is set to a multiple of the sub-interval, the connection between the ACL channel and the ISO channel can be continuously maintained without collision thereafter.

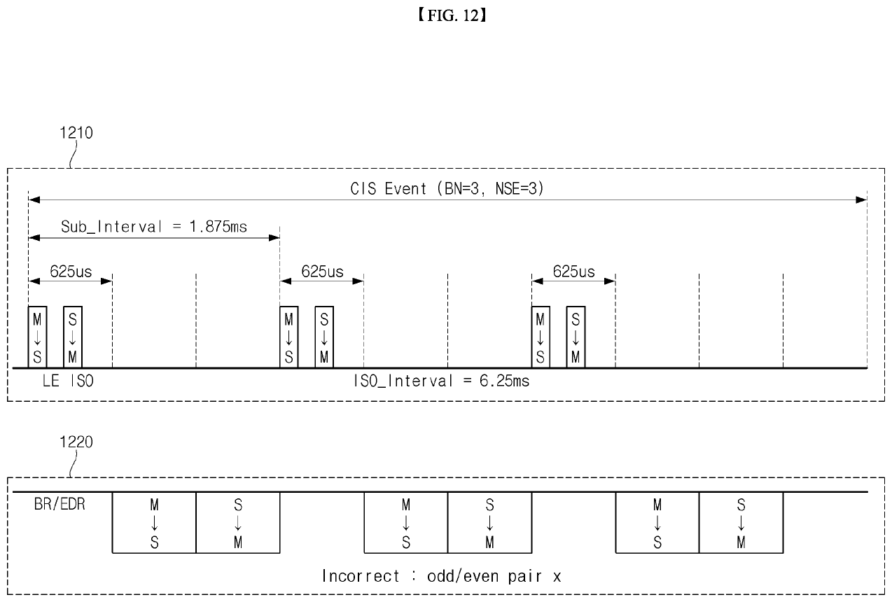

FIG. 11 illustrates another example of performing data transmission and reception between a master device and a slave device. More specifically, FIG. 11 illustrates an example where a plurality of ISO intervals and a plurality of connection intervals are repeated, unlike FIG. 9 illustrating one ISO interval and one connection interval. In FIG. 11, a sub-interval is 1.25 ms. In particular, FIG. 11 illustrates that when a connection interval of an ACL channel is set to a multiple of the sub-interval, a collision between data transmission and reception timing on the ACL channel and data transmission and reception timing on the ISO channel does not occur. Since 625 us-based timing exists in the existing LE ACL, the 625 us-based timing may be set for ease of implementation. In this case, since it is difficult to secure a space for other traffic in 625 us Sub_Interval, minimum Sub_Interval may be 1.25 ms. In this instance, parameters for data transmission and reception on the ACL channel may be set as follows.

$$1 ) Advertising Interval = 625 us \times N ( 20 ms ∼ 10 , 485 s ) \\ 2 ) Connection Interval = 1.25 ms \times N ( 7.5 ms ∼ 4 s ) \\ 3 ) TransmitWindowOffset = 1.25 ms \times N \\ 4 ) TransmitWindowSize = 1.25 ms \times N$$

Connection_Interval may be set to a multiple of 1.25 ms. In this instance, data transmission and reception timing on the ACL channel may not collide with data transmission and reception timing on the ISO channel.

However, as in a reference numeral 1120 of FIG. 11, since an LE connection interval (ACL) is a multiple of 1.25 ms, and the parameters for data transmission and reception on the ACL channel described above are a multiple of 1.25 ms, the connection interval may be already a multiple of the sub-interval if the sub-interval is set to 1.25 ms. Therefore, parameters that prevent a collision between the ACL channel and the ISO channel can be easily found. However, in this case, since a minimum polling interval of USB selects 1.25 ms longer than 1 ms, the USB may have worse performance than wired HID. However, performance deterioration depends on how quickly the application processes HID input, and in most gaming services, there may not be a significant difference in performance.

FIG. 12 illustrates another example of performing data transmission and reception between a master device and a slave device. More specifically, FIG. 12 illustrates an example where data transmission and reception timing is set so that after data transmission and reception in a sub-event of the ISO channel is completed, data transmission and reception through BR/EDR (1220) is performed in a remaining portion 1210 of a sub-interval. In FIG. 12, considering 625 us slot timing of the BR/EDR, at least one pair of BR/EDR slots shall be inserted between LE ISO sub-events. In this case, minimum Sub_Interval of an LE ISO channel may be set to (625 us+1.25 ms=1.875 ms).

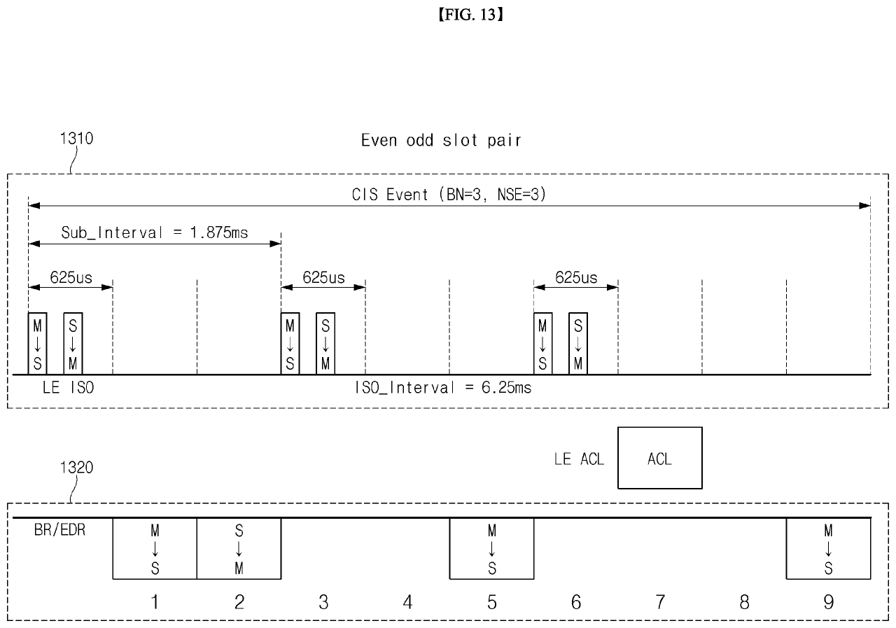

FIG. 13 illustrates another example of performing data transmission and reception between a master device and a slave device. More specifically, FIG. 13 illustrates an example where data transmission and reception timing is set so that after data transmission and reception in a sub-event of the ISO channel is completed, data transmission and reception through BR/EDR and data transmission and reception through LE ACL (1320) are performed in a remaining portion 1310 of a sub-interval. In FIG. 13, considering 625 us slot timing of the BR/EDR, at least one pair of BR/EDR slots shall be inserted between LE ISO sub-events. In this case, minimum Sub_Interval of an LE ISO channel may be set to (625 us+1.25 ms=1.875 ms). FIG. 13 illustrates an example of allocating BR/EDR slots by matching BR/EDR even/odd pairs. In FIG. 13, since the master device cannot transmit data in slots of Nos. 3 and 4 due to a collision with the sub-interval, data transmission through the BR/EDR is skipped. Further, the slave device cannot transmit data in a slot of No. 6 due to a collision with the sub-interval. In this instance, even in the sub-interval, data may not be transmitted due to the collision. In a slot of No. 7, the master device allocates ACL packets, and a slot of No. 8 is a slot in which data transmission of the slave device is performed, but is empty because the master device has not transmitted anything. Since there is no sub-event in a slot of No. 9, the master deice may transmit data through the BR/EDR.

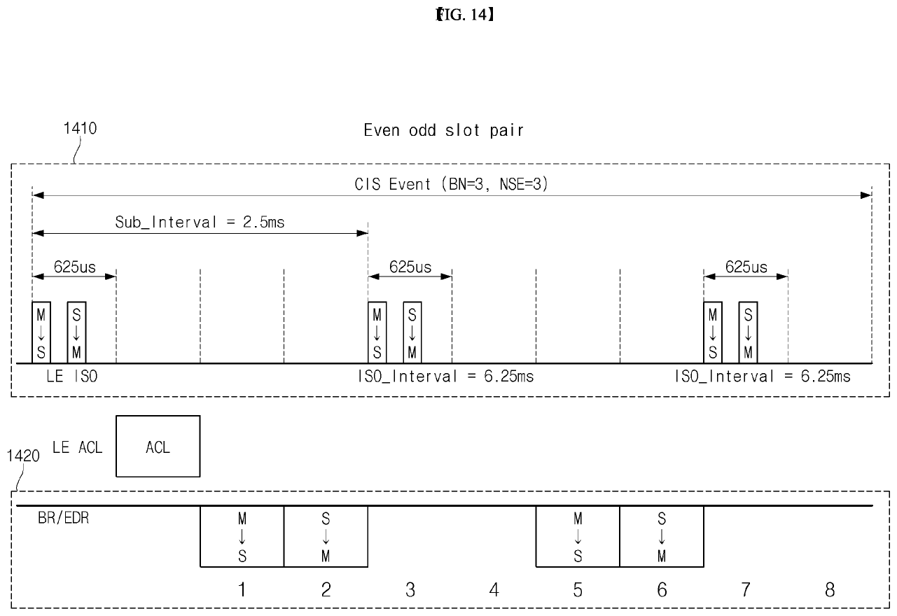

FIG. 14 illustrates another example of performing data transmission and reception between a master device and a slave device. More specifically, FIG. 14 illustrates an example where data transmission and reception timing is set so that after data transmission and reception in a sub-event of the ISO channel is completed, data transmission and reception through BR/EDR and data transmission and reception through LE ACL (1420) are performed in a remaining portion 1410 of a sub-interval. In FIG. 14, considering 625 us slot timing of the BR/EDR, a slot for ACL data transmission and at least one pair of BR/EDR slots shall be inserted between LE ISO sub-events. In this case, minimum Sub_Interval of an LE ISO channel may be set to 2.5 ms. FIG. 14 illustrates an example of allocating BR/EDR slots by matching BR/EDR even/odd pairs. In FIG. 14, the BR/EDR always has the opportunity to be sent at regular intervals (1, 2 and 5, 6 . . . ). Slots of Nos. 4 and 8 are empty for ACL, and the ACL is used based on a relatively long interval. Therefore, every fourth empty slot can be used for transmission of other Bluetooth packet (primary advertising, secondary advertising, periodic advertising, inquiry, page).

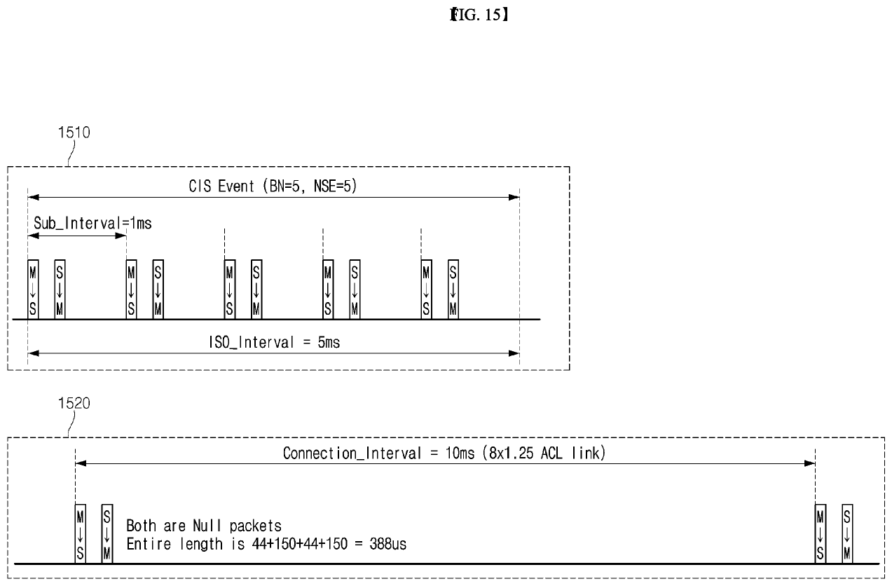

FIG. 15 illustrates another example of performing data transmission and reception between a master device and a slave device. FIG. 15 illustrates an example where ISO sub-interval is set to 1 ms. In FIG. 15, settings for data transmission and reception may be as follows.

$$Packet = Preamble ( 2 byte ) + AccessAddress ( 4 byte ) + PSU + CRC ( 3 byte ) \\ PDU = Header ( 2 byte ) + Payload ( 0 ∼ 251 ) byte \\ Header = LLID , NESN , SN , CIE , RFU , NPI , RFU + Len ( 1 byte )$$

Overhead to Payload is 11 byte (88 bit, 44 us)

M->S: Null packet (Poll), Packet time=44 us

S->M:Payload (Mouse)=4 byte, Packet time=44 us+16 us=60 us

$$Minimum SE\_Length = M -> S + T\_IFS + S -> M + T\_MSS = 44 + 150 + 60 + 150 = 404 us$$

To summarize what is described above, for 4-octet HID payload, a minimum SE_length may be 492 us (1M PHY) and 404 us (2M PHY). Further, if 1 ms Sub_Interval is set, more than 50% of a network bandwidth may remain. When the timing is correctly set, ACL and ISO may not collide. In this instance, when Sub_Interval is set to 1.25 ms, scheduling of ACL may become easier. A minimum value of Sub_Interval may be 1.25 ms not 1 ms.

Poll in the sub-event is essential. If a peripheral device does not receive a packet from a central device of the same sub-event, regarding not transmitting, similar to what is done for periodic advertisements with multiple responses, in one CIS event, only one polling of the central device is allowed and then responses of multiple peripheral devices may be performed. If the peripheral device is configured to respond at fixed intervals, it may not help much with scheduling, but it can save power and be less aggressive with airtime.

The associated ACL is necessary. In relation to “the CIS shall be associated with the ACL used to generated the ACL”, “if the ACL connection between the master device and the slave device is terminated, all the associated CISs shall be terminated simultaneously”, “the ACL connection or the CIS connection may be terminated at the link layer using an ACL termination procedure”, and “each CIS shall be associated with the ACL,” if the ACL is terminated, the CIS is also terminated. In other words, the ACL may be paused, similar to what is possible with BR/EDR.

For the ACL, “the link layer shall reserve the CIS so that a CIS event does not overlap a connection event of the connected ACL.” If the ISO and the ACL are scheduled with fine-grained scheduling described in a timing slide, a collision may not occur. However, for ease of implementation, coarse scheduling may be allowed where a collision between ISO timing and ACL timing may occur. In this instance, the collision may be recovered by retransmission at the next scheduled timing. Alternatively, the ACL may be paused after configuring the ISO. If it is configured so that the data transmission timing in the ISO and the transmission timing in the ACL collide, the data transmission in the ISO may be dropped, and the data transmission in the ACL may be performed. That is, if the data transmission in the ISO and the data transmission in the ACL overlap each other, the data transmission in the ACL may have higher priority. In this instance, the data transmission in the dropped ISO may be retransmitted at a next transmission timing of the transmission timing of the dropped ISO data.

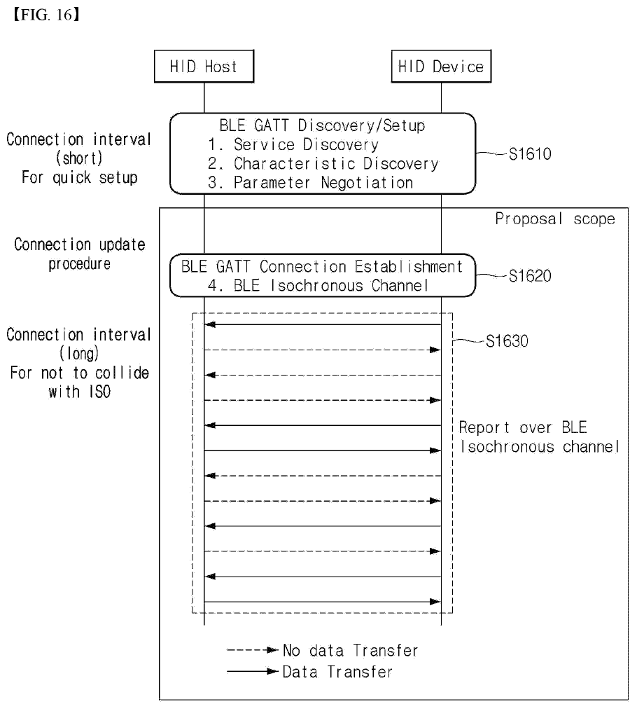

FIG. 16 is a flowchart illustrating an example of performing a method described in the present disclosure.

S1610: A procedure is performed to form a BLE connection between a HID host and a HID device. In this instance, the procedure for forming the BLE connection may include service discovery, feature discovery, and parameter negotiation.

S1620: As a result of S1610, the BLE connection between the HID host and the HID device is formed. Thereafter, a BLE isochronous (ISO) channel is formed between the HID host and the HID device through the formed BLE connection.

S1630: Next, data transmission and reception between the HID host and the HID device is performed on the formed ISO channel.

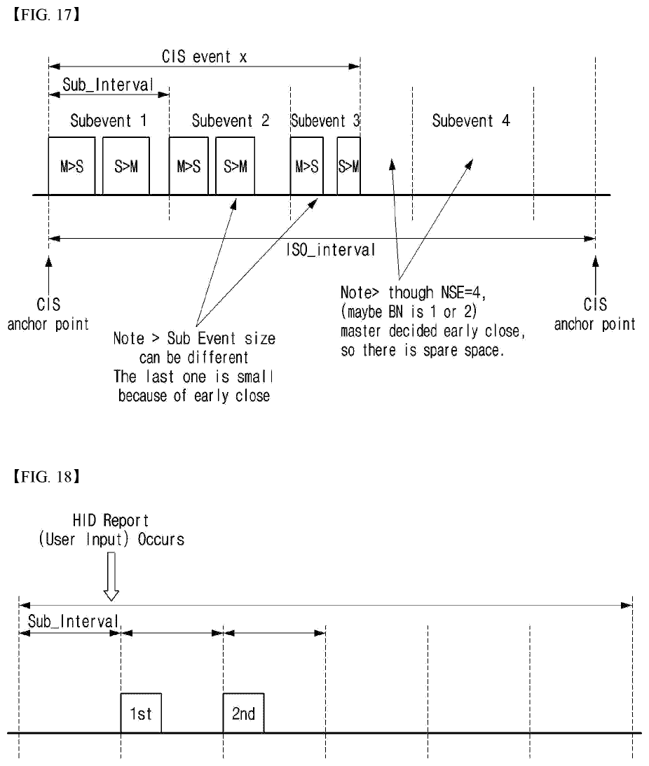

FIG. 17 illustrates another example of Bluetooth isochronous (ISO) architecture.

Referring to FIG. 17, a master device shall transmit a packet when each sub-event starts until a CIS event is closed. If a slave device receives the packet from the master device, the slave device may transmit response T_IFS after the master's packet ends, regardless of whether the CRC is valid. In this instance, if the slave device does not receive the packet from the master device in the same sub-event, the slave device does not transmit it. If one of the two devices does not transmit data during the sub-event, the link layer shall operate for other purposes (e.g., packet timing and payload selection) as if it had performed data transmission. The link layer ends the CIS event in an end portion of the last sub-event. The master device or the slave device may also close early the CIS event using close isochronous event (CIE) bit. A device transmitting a CIS PDU with the CIE bit set to 1 does not transmit data in the remaining sub-event of the current CIS event. In general, if all payloads scheduled in both directions are transmitted and acknowledged, the link layer implementation is configured to early end the CIS event.

For ultra-low latency (ULL) data, because the length of the sub-event is short, even half of the set length of Sub_Interval may not be used. Therefore, an end portion of the entire Sub_Interval generally remains unused for data transmission. If a scheduler that utilizes the remaining portion of Sub_Interval that is not used for data transmission is configured, ACL traffic or other LE traffic may be mixed with ISO traffic.

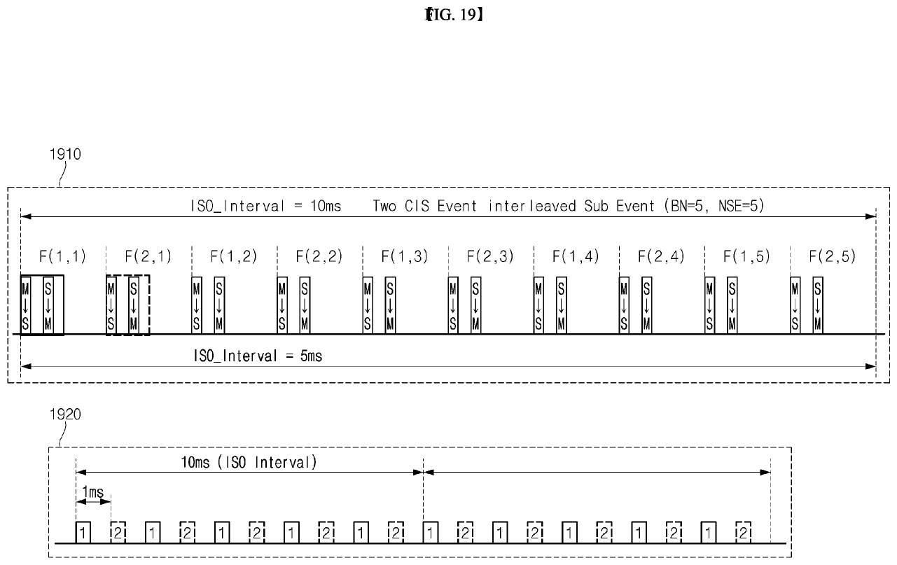

FIG. 18 illustrates an example of data transmission and reception on ISO channel.

Referring to FIG. 18, when a user input is input to a slave device in a CSI interval, a HID report occurs. SDU_Interval may be a HID report interval and may have a length of 1 ms, 2 ms, 4 ms or 1.25 ms, 2.5 ms or 5 ms. HID Report's may be transmitted in a first or second sub-interval after the user input. A size of the Sub_Interval may be the same as the size in ISO-interval. Since HID Report data is small, there is generally an empty portion at an end portion of Sub_Interval. In this instance, repeated transmission is not necessary.

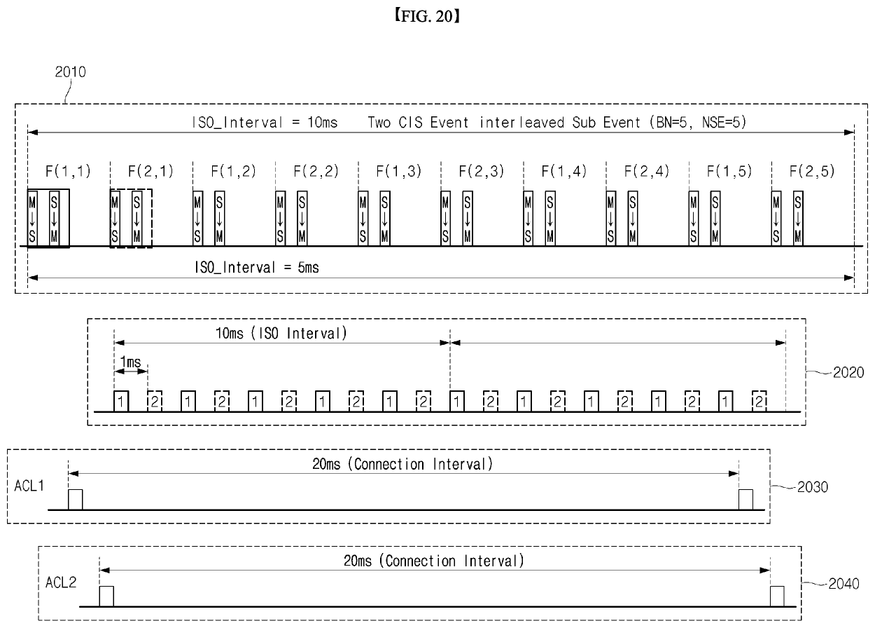

FIG. 19 illustrates an example of performing data transmission and reception between a master device and a slave device. More specifically, FIG. 19 illustrates an example of performing data transmission and reception between (i) a plurality of slave devices and (ii) a master device. FIG. 19 illustrates an example of performing data transmission and reception between two slave devices and a master device, but the method described in the present disclosure is not limited thereto. In FIG. 19, a reference numeral 1910 denotes one ISO interval based on a CIS channel formed between the master device and the slave device, and a reference numeral 1920 denotes two ISO intervals based on a CIS channel formed between the master device and the slave device. In FIG. 19, the ISO interval has a length of 10 ms, five sub-intervals are allocated to each of the two slave devices, and one ISO interval includes a total of ten sub-intervals. Each sub-interval may be interleaved. For the two slave devices, ISO_Interval may be a multiple of 2, and in this case, a delay of 2 ms may occur for each device. For the three slave devices, ISO_Interval may be a multiple of 3, and in this case, a delay of 3 ms may occur for each device. For the four slave devices, ISO_Interval may be a multiple of 4, and in this case, a delay of 4 ms may occur for each device.

FIG. 20 illustrates an example of performing data transmission and reception between a master device and a slave device. More specifically, FIG. 20 illustrates an example of performing data transmission and reception between (i) a plurality of slave devices and (ii) a master device. FIG. 20 illustrates an example of performing data transmission and reception between two slave devices and a master device, but the method described in the present disclosure is not limited thereto. In FIG. 20, a reference numeral 2010 denotes one ISO interval based on a CIS channel formed between the master device and the slave device, and a reference numeral 2020 denotes two ISO intervals based on a CIS channel formed between the master device and the slave device. In FIG. 20, reference numerals 2030 and 2040 denote ACL channels formed between each of the two slave devices and the master device. In FIG. 20, data transmission timing on ACL1 and ACL2 (2030 and 2040) is set not to overlap data transmission timing on the ISO channel, and lengths of the ACL1 and the ACL2 (2030 and 2040) are set to a multiple (20 ms) of sub-interval. Hence, it can be seen that subsequently repeated transmission timing on the CIS channel and subsequently repeated transmission timing on the ACL channel do not overlap each other.

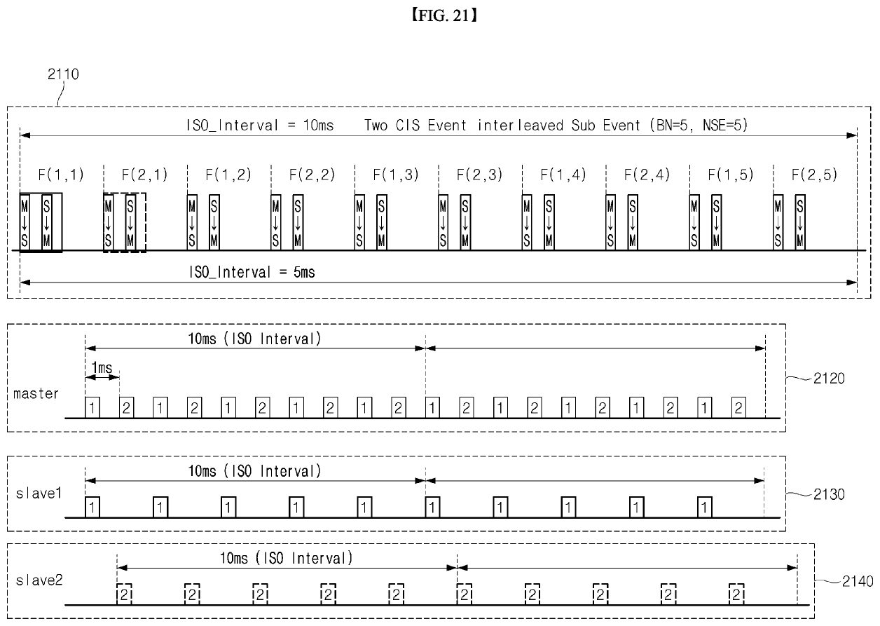

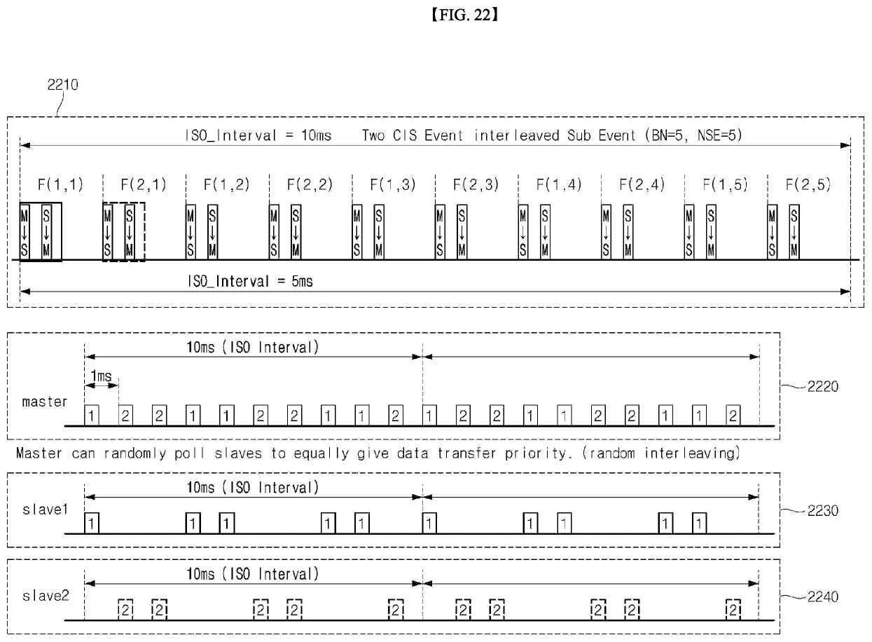

FIG. 21 illustrates an example of performing data transmission and reception between a master device and a slave device. More specifically, FIG. 21 illustrates an example of performing data transmission and reception between (i) a plurality of slave devices and (ii) a master device. FIG. 21 illustrates an example of performing data transmission and reception between two slave devices and a master device, but the method described in the present disclosure is not limited thereto. In FIG. 21, a reference numeral 2110 denotes one ISO interval based on a CIS channel formed between the master device and the slave device, and a reference numeral 2120 denotes poll transmission timing of the master device in two ISO intervals based on a CIS channel formed between the master device and the slave device. In FIG. 21, reference numerals 2130 and 2140 denote data transmission timing of the slave devices in two ISO intervals based on the CIS channel formed between the slave devices and the master device.

In the reference numeral 2110 of FIG. 21, the ISO interval has a length of 10 ms, five sub-intervals are allocated to each of the two slave devices, and one ISO interval includes a total of ten sub-intervals. Each sub-interval may be interleaved. In FIG. 21, the master device performs polling on the two slave devices through two ISO connections respectively formed with the two slave devices, and the slave device transmits data in response to the polling. In this instance, in the ISO interval, the master device may sequentially perform the polling on the two slave devices. That is, the polling may be repeatedly performed in order of the master device->the slave device 1->the slave device 2.

The sub-interval may be set to 2 ms for two slave devices, the sub-interval may be set to 3 ms for three slave devices, and the sub-interval may be set to N ms for N slave devices. In this instance, a connection satisfying the minimum delay can be formed.

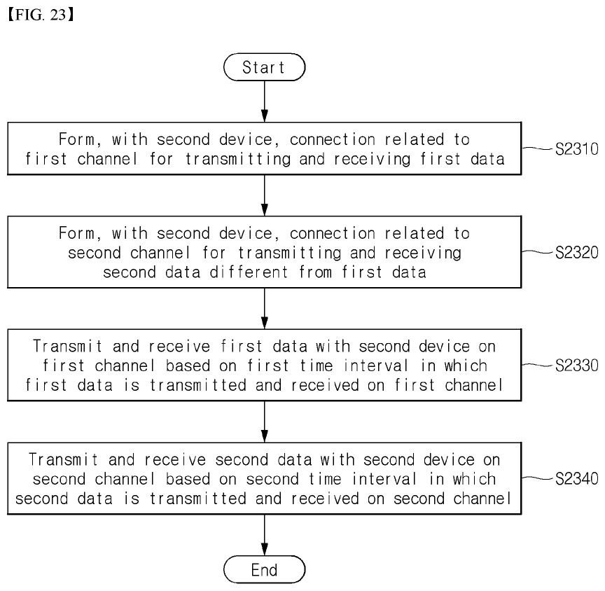

FIG. 22 illustrates another example of performing data transmission and reception between a master device and a slave device. More specifically, FIG. 22 illustrates an example of performing data transmission and reception between (i) a plurality of slave devices and (ii) a master device. FIG. 22 illustrates an example of performing data transmission and reception between two slave devices and a master device, but the method described in the present disclosure is not limited thereto. In FIG. 22, a reference numeral 2210 denotes one ISO interval based on a CIS channel formed between the master device and the slave device, and a reference numeral 2220 denotes poll transmission timing of the master device in two ISO intervals based on a CIS channel formed between the master device and the slave device. In FIG. 22, reference numerals 2230 and 2240 denote data transmission timing of the slave devices in two ISO intervals based on the CIS channel formed between the slave devices and the master device.

In the reference numeral 2210 of FIG. 22, the ISO interval has a length of 10 ms, five sub-intervals are allocated to each of the two slave devices, and one ISO interval includes a total of ten sub-intervals. Each sub-interval may be interleaved. In FIG. 22, the master device performs polling on the two slave devices through two ISO connections respectively formed with the two slave devices, and the slave devices transmit data in response to the polling. In this instance, in the ISO interval, the master device may randomly perform the polling on the two slave devices. That is, in one sub-interval, the master device may irregularly perform the polling in order of the slave device 1->the slave device 2 or in order of the slave device 2->the slave device 2. As the master device randomly performs the polling, fairness between users of the respective slave devices can be guaranteed when using gaming services.

The sub-interval may be set to 2 ms for two slave devices, the sub-interval may be set to 3 ms for three slave devices, and the sub-interval may be set to N ms for N slave devices. In this instance, a connection satisfying the minimum delay can be formed.

FIG. 23 is a flowchart illustrating an example where a method of transmitting and receiving data in a short-range wireless communication system described in the present disclosure is performed by a first device.

More specifically, the first device forms, with a second device, a connection related to a first channel for transmitting and receiving first data, in S2310.

Next, the first device forms, with the second device, a connection related to a second channel for transmitting and receiving second data different from the first data, in S2320.

Subsequently, the first device transmits and receives the first data with the second device on the first channel based on a first time interval in which the first data is transmitted and received on the first channel, in S2330.

Next, the first device transmits and receives the second data with the second device on the second channel based on a second time interval in which the second data is transmitted and received on the second channel, in S2340.

The data transmission and reception on the first channel and the data transmission and reception on the second channel are performed based on transmission and reception timing of the first data in the first time interval and transmission and reception timing of the second data in the second time interval.

It is apparent to those skilled in the art that the present disclosure can be embodied in other specific forms without departing from essential features of the present disclosure. Accordingly, the above detailed description should not be construed as limiting in all aspects and should be considered as illustrative. The scope of the present disclosure should be determined by rational construing of the appended claims, and all modifications within an equivalent scope of the present disclosure are included in the scope of the present disclosure.

The embodiments described above are implemented by combinations of components and features of the present disclosure in predetermined forms. Each component or feature should be considered selectively unless specified separately. Each component or feature can be carried out without being combined with another component or feature. Moreover, some components and/or features are combined with each other and can implement embodiments of the present disclosure. The order of operations described in embodiments of the present disclosure can be changed. Some components or features of one embodiment may be included in another embodiment, or may be replaced by corresponding components or features of another embodiment. It is apparent that some claims referring to specific claims may be combined with another claims referring to the claims other than the specific claims to constitute the embodiment or add new claims by means of amendment after the application is filed.

Embodiments of the present disclosure can be implemented by various means, for example, hardware, firmware, software, or combinations thereof. When embodiments are implemented by hardware, one embodiment of the present disclosure can be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

When embodiments are implemented by firmware or software, one embodiment of the present disclosure can be implemented by modules, procedures, functions, etc. performing functions or operations described above. Software code can be stored in a memory and can be driven by a processor. The memory is provided inside or outside the processor and can exchange data with the processor by various well-known means.

It is apparent to those skilled in the art that the present disclosure can be embodied in other specific forms without departing from essential features of the present disclosure. Accordingly, the above detailed description should not be construed as limiting in all aspects and should be considered as illustrative. The scope of the present disclosure should be determined by rational construing of the appended claims, and all modifications within an equivalent scope of the present disclosure are included in the scope of the present disclosure.

### INDUSTRIAL APPLICABILITY

The preferred embodiments of the present disclosure described above are disclosed for an exemplary purpose, and modifications, changes, substitutions, or additions of various other embodiments can be made by those skilled in the art within the technical spirit and the technical scope of the present disclosure described in the appended claims below.

1. A method of transmitting and receiving, by a first device, data in a short-range wireless communication system, the method comprising:
forming, with a second device, a connection related to a first channel for transmitting and receiving first data;
forming, with the second device, a connection related to a second channel for transmitting and receiving second data different from the first data;
transmitting and receiving the first data with the second device on the first channel based on a first time interval in which the first data is transmitted and received on the first channel; and
transmitting and receiving the second data with the second device on the second channel based on a second time interval in which the second data is transmitted and received on the second channel,
wherein a data transmission and reception on the first channel and a data transmission and reception on the second channel are performed based on a transmission and reception timing of the first data in the first time interval and a transmission and reception timing of the second data in the second time interval.

2. The method of claim 1, wherein forming the connection related to the second channel comprises transmitting, to the second device, information on a time offset from a start time of the first time interval to a start time of the second time interval, and
wherein the second time interval is configured based on the information on the time offset.

3. The method of claim 2, wherein, based on the information on the time offset, the transmission and reception timing of the first data in the first time interval is configured not to overlap the transmission and reception timing of the second data in the second time interval.

4. The method of claim 3, wherein the data transmission and reception on the first channel is performed between a time, at which the transmission and reception of the second data on the second channel in the second time interval is completed, and an end time of the second time interval, and
wherein a length of the first time interval is set to a multiple of the second time interval.

5. The method of claim 2, wherein, based on the information on the time offset, the transmission and reception timing of the first data in the first time interval and the transmission and reception timing of the second data in the second time interval are configured to overlap each other at least once.

6. The method of claim 5, wherein at least one transmission and reception of the second data in the second time interval, that overlaps the transmission and reception timing of the first data in the first time interval, is dropped, and
wherein at least one transmission and reception of the first data in the first time interval, that overlaps the transmission and reception timing of the second data in the second time interval, is performed.

7. The method of claim 6, wherein the dropped at least one transmission and reception of the second data in the second time interval, that overlaps the transmission and reception timing of the first data in the first time interval, is retransmitted in at least one next second time interval of the second time interval, that overlaps the transmission and reception timing of the first data in the first time interval.

8. The method of claim 1, wherein the first device is a central device,
wherein the second device is a peripheral device, and
wherein the second data is data generated based on a user input of the second device.

9. The method of claim 8, wherein the first data is null data, and
wherein the second data is data requiring a low delay.

10. A first device transmitting and receiving data in a short-range wireless communication system, the first device comprising:
a transmitter configured to transmit a radio signal;
a receiver configured to receive the radio signal;
at least one processor; and
at least one computer memory operably connectable to the at least one processor,
wherein the at least one computer memory is configured to store instructions performing operations based on being executed by the at least one processor,
wherein the operations comprise:
forming, with a second device, a connection related to a first channel for transmitting and receiving first data;
forming, with the second device, a connection related to a second channel for transmitting and receiving second data different from the first data;
transmitting and receiving the first data with the second device on the first channel based on a first time interval in which the first data is transmitted and received on the first channel; and
transmitting and receiving the second data with the second device on the second channel based on a second time interval in which the second data is transmitted and received on the second channel,
wherein a data transmission and reception on the first channel and a data transmission and reception on the second channel are performed based on a transmission and reception timing of the first data in the first time interval and a transmission and reception timing of the second data in the second time interval.
